(19) United States
(12) Patent Application Publication
(10) Pub. No.: US 2005/0245416 A1
(43) Pub. Date: Nov. 3, 2005

(54) Unit dose granulated detergent for cleaning a coffee machine

(76) Inventors: Jan Eduardo Veening, Sint Pietersberg (NL); Robert-Jan Reinier Uhlhorn, Lingedijk (NL)

Correspondence Address: JohnsonDiversey, Inc.;M/S 509, 8310 16th Street, P.O. Box 902, Sturtevant, WI, 53177-0902, US

(21) Appl. No.: 11/110,508

(22) Filed: Apr. 20, 2005

(30) Foreign Application Priority Data
Apr. 29, 2004 (EP) 04 101 820.1

(51) Int. Cl. C11D 17/00; C11D 17/06

(52) U.S. Cl. 510/295

(57) ABSTRACT

The invention relates to a unit dose detergent for cleaning a coffee machine consisting of a water-soluble sachet filled with a detergent composition comprising: a) 10-40 wt. % of a sequestering agent; b) 15-50 wt. % of a persalt or peracid; c) 0.1-10 wt. % of a scale inhibitor selected from phosphonate and a carboxyl-functional polymer; d) a sufficient amount of an alkaline compound to obtain a pH of at least 10 when the composition is dissolved in water; and e) optionally, to a total of 100 wt. % of ingredients a) to e) of at least one auxiliary agent;
wherein 30-100 wt. % of the total of a) to e) is in the form of granules having a mean particle size 250-800 μm, a BET specific surface area of less than 100 m²/g, and a dissolution rate of less than 1 min in 100 ml of water of 90° C., and to a method of cleaning a coffee machine by dissolving said unit dose detergent.

The invention relates to a unit dose detergent for cleaning a coffee machine and to a method of cleaning such coffee machine by dissolving the unit dose detergent in the water tank thereof.

Methods for cleaning coffee machines are known, for instance, such as disclosed in U.S. Pat. No. 6,514,429. This patent describes the art, i.e. a cleaning method wherein the water tank is cleaned by applying a cleaning tablet. This patent discloses the use of a composition for use in a water tank wherein a base composition is in the form of a tablet, which evolves its function essentially following addition to a first filling of the water tank, and wherein one particle having a core comprising a substance evolving its function substantially following emptying of the first filling from the water tank and inflow of fresh water to the same. The tablet has a covering surrounding the core and comprising a compound, whose solubility increases with decreasing concentration of H— ion in the surrounding medium. The solubility of the compound increases with decreasing OH— ionic concentration and therefore decreasing pH value in the surrounding medium. Tablet ingredients comprise amidosulfuric acid, maleic acid, and sodium hydrogencarbonate. A particular suitable tablet contains sodium tripolyphosphate, sodium carbonate, sodium bicarbonate, trisodium NTA, sodium metasilicate, sodium sulfate, sodium dichloroisocyanurate, polymer, and nonionic surfactant. Further the compound may comprise a pH-sensitive polymer, which comprises at least one repeating unit having at least one basic function, which is not part of the polymer backbone chain, and which is preferably a secondary or tertiary amine.

It is known that such tablets have a long dissolution time, and commercially available tablets need about 1 h or even more to completely dissolve in the water tank. Such long dissolution times pose a burden to maintenance personnel, which have to clean such machines that are commonly placed in offices, industrial plants, and the like. As a consequence of the poor dissolution properties, the known tablets have poor cleaning efficiency, long cleaning cycles, and suffer from disintegration during storage, transportation, and handling. They further are less desired because they can lead to skin contact with detergent during handling, particularly when handling of disintegrated tablets which may easily lead to residual detergent on the hands of the operator thereby creating a risk of food/detergent contact. An alternative for tablets would be a liquid detergent, which guarantees very short dissolution times. However, liquid detergents which are dosed from bottles suffer from many unacceptable disadvantages such that it cannot be dosed into most of the machines used currently, and if dosed it is difficult to prevent spillages in the machine. Therefore there is a serious risk of food/detergent contact, corrosion of the machine, and uncontrolled detergent dosing. Further, residual product may remain in the machine after the cleaning cycle if overdosed, which overdose could damage the machine.

It is therefore an objective of the present invention to provide a composition that is able to dissolve quickly, most preferably (almost) simultaneously with bringing it in contact with water, thereby increasing the efficiency of the cleaning operation significantly, and which further eliminates the disintegration and food/detergent contact risks.

To this end the invention pertains to a unit dose detergent for cleaning a coffee machine consisting of a water-soluble sachet filled with a composition comprising:
a) 10-40 wt. % of a sequestering agent;
b) 15-50 wt. % of a persalt or peracid;
c) 0.1-10 wt. % of a scale inhibitor selected from phosphonate and a carboxyl-functional polymer;
d) a sufficient amount of an alkaline compound to obtain a pH of at least 10 when the composition is dissolved in water; and
e) optionally, to a total of 100 wt. % of ingredients a) to e) of at least one auxiliary agent;
   wherein 30-100 wt. % of the total of a) to e) is in the form of granules having a mean particle size 250-800 μm, a BET specific surface area of less than 100 m²/g, and a dissolution rate of less than 1 min in 100 ml of water of 90° C. It is preferred to obtain as much as possible granules in the composition, but practically the amount is restricted because of the commercial availability of the ingredients in the form of granules. Practically, therefore a total amount of 40-60 wt. % granules is preferred.

The invention resides in a unit dose detergent which is able to clean extremely fast and reliable. The sachet (or pouch) of the invention is suitable for quick cleaning cycles of food and beverage service applications where manual dosing of cleaning chemicals is desired. It does not dissolve during handling but dissolves quickly within 1 min, preferably within 45 sec, during the cleaning cycle.

Cleaning cycles used in this area normally use very small quantities of water and the level of both pressure and agitation applied on this water is very low. For this reason the superior dissolution characteristics of the unit dose of the invention is crucial.

The term “coffee machine” within the context of the present inventions includes machines for food and beverage service applications like hot and cold drink vending machines, particularly such as machines for making coffee, espresso, cappuccino, tea, chocolate, and the like.

The composition comprising granules, or optionally a mixture of granules and powder, includes a persalt or peracid as ingredient which creates some degree of agitation of the cleaning solution by gas release without neutralization of the cleaning solution, thereby increasing the dissolution rate.

Due to the presence of granular material in the composition, the active ingredients in the sachet are made available in the cleaning solution almost as quickly as when a liquid detergent would have been used. It also provides complete cleaning in the same time as a liquid detergent without encountering all the problems which are associated with the use of liquid detergents.

The sachet material is preferably cold water-soluble PVA (polyvinyl alcohol). Such sachets are known in the art. For instance in U.S. Pat. No. 4,844,828 a detergent dispenser which comprises a powder detergent and a pouch or bag containing the powder detergent has been disclosed, wherein the pouch is made of a cold water-soluble polyvinyl alcohol derivative. The pouch is resistant to acid and to alkali and can retain its solubility over a long period of time. The pouch or bag contains a powder detergent which is capable of dissolving when it is placed into water. The powdery detergents described are inorganic components dispersed in a continuous phase comprising an organic component constituting the detergent composition. The organic component is a surfactant, usually an anionic or non-ionic surfactant, and the inorganic component is a powdery alkali. However, these powder detergents are intended for laundry and dishwashing and are unable to dissolve within 1 min and for that reason are unsuitable for cleaning coffee machines. The polyvinyl alcohols, however, can be applied as a water-soluble polymer which is widely used for water-soluble films and in other fields. PVA which has a degree of saponification ranging from 80 to 95 mol % exhibits rapid water solubility. PVA which has a degree of saponification of at least 98 mol % is called and is less suitable since it dissolves in water when it is allowed to stand in the water for a long period of time or if it is placed into hot water.

Preferred sequestering agents are compounds that have a strong complexation with or bonding to calcium and magnesium. Most preferred are sodium or potassium salts of NTA (nitrilotriacetic acid), MGDA (methylglycine-diacetic acid), EDTA (ethylenediamine tetraacetic acid), and (S,S)-EDDS (ethylenediamine-N,N′-disuccinic acid), or mixtures thereof. Preferred amounts of the sequestering agent amount to 20-30 wt. %.

Preferred persalts are percarbonate and perborate. Preferably, the counter ion is an alkali metal such as sodium or potassium. Preferred peracids are sodium or potassium salts of phthalimidoperhexanoic acid (PAP) and peracetic acid (PAA). Preferred amounts of the peroxy compound amount to 22-35 wt. %.

Preferred scale inhibitors are phosphonates such as, sodium or potassium salts of ethanehydroxydiphosphonic acid and aminotrimethylenephosphonic acid, and carboxyl-functional polymers such as poly(meth)acrylic acid, and copolymers of (meth)acrylic acid and maleic acid or anhydride. Preferred amounts of the phosphonate or carboxyl-functional polymer amount to 3-7 wt. %.

The alkaline compound may be any compound that is able to bring the pH to at least 10. Suitable alkaline compounds include metasilicate, granulated or powder-like silicate, disilicate, sodium hydroxide, sodium carbonate, sodium hydrogencarbonate, and the like.

The composition may further comprise auxiliary compounds to complete the composition to 100 wt. %. Suitable auxiliary compounds include phosphates (such as sodium tri(polyphosphate), sodium pyrophosphate, and sodium orthophosphate), sequestering agents other than those of a), perfumes, colorants, fillers, emulsifiers and the like. These additional compounds may be used as granules or powders, or mixtures thereof.

The active ingredients in the composition are at least partly granular and may be partly powder. The granular components are preferably NTA, sodium percarbonate and sodium metasilicate, but the other component may also be used in granular form. The amount of granular material should be in the range of 30 to 100 wt. %, preferably 40-90 wt. %, more preferably 60-80 wt. %. The granular material is material with a particle size ranging from 250-800 micron, preferably be about 300-750 micron, most preferably 350-500 micron. The BET specific surface area is less than 100 m²/g, preferably less than 90 m²/g, most preferably less than 80 m²/g.

A suitable method for cleaning coffee machines is to dose the sachet containing the composition to the water tank (also known as brewer) and to add water. For instance, the brewer is charged with the sachet and 20 ml of water having a temperature of 90° C. to 95° C. After a delay time of about 10 seconds to allow the sachet to dissolve at least partially, the brewer is filled by charging an additional amount of 80 ml of water of 90° C. to 95° C. The sachet and granule/powder mixture quickly dissolve. The brewer stays filled with the cleaning solution for 40 seconds which allows complete dissolution and gives excellent brewer cleaning. The brewer is then discharged and flushed to remove all traces of detergent.

The invention is further illustrated by the following non-limitative examples.

### EXAMPLES

A sachet made of PVA (polyvinyl alcohol type M8630 or E6030, ex Monosol) filled with the composition according to the invention (see below) was dosed to the brewer of a MAAS type Freshbrewer™ coffee machine. The brewer was closed and charged with 20 ml of water having a temperature of 95° C. A delay time of 10 seconds was allowed for sachet dissolution. After the delay time the brewer was fully filled by charging an additional 80 ml of water. The sachet and contents thereof were quickly dissolved. The brewer stayed filled with the cleaning solution for 40 seconds in which full dissolution and brewer cleaning was achieved. The brewer was discharged. Finally, the brewer was flushed to remove all cleaning solution traces. The same procedure was repeated with a powder and a tablet.

When a sachet was used filled with a powder-like detergent only, the dissolution rate in a cleaning procedure as described hereinabove was insufficient. The consequence of insufficient dissolution rate is that powder accumulates onto the bottom of the system resulting to a total dissolution time which is approximately the same as that of a tablet. Extensive testing revealed that wetted powder is poorly accessible for water, which causes insufficient dissolution rate.

It was also found that a sachet filled with powder-like detergent in combination with an arbitrary chosen porous granular detergent material provided insufficient dissolution rate. Extensive testing revealed that arbitrary porous granulates stick together as a result of capillary effects.

It was surprisingly found that a sachet filled with a powder-like detergent in combination with specific granular detergent material, i.e. with granules having a specific size and BET specific surface area, very good dissolution characteristics were obtained making the dissolution rate of the total system sufficiently fast.

The following experiment shows dissolution data of comparative compositions and compositions of the invention.

### EXAMPLE

### Dissolution Rate of a Sachet (According to the Invention) vs. Powder and Tablet (Comparative)

A transparent cup was filled with water of 90° C. The sachet, powder or tablet was added and allowed to (partially) dissolve for 10 seconds. The water was agitated using a stirrer for 3 seconds (which simulates the filling of the system). The time was measured to dissolve all the material of sachet, powder or tablet.

The following compositions were used:

Sachet Filled with Granular Material:

| | |
|---|---|
| sodium tri(polyphosphate) | 10 wt. % powder |
| sodium NTA | 24 wt. % granules |
| sodium percarbonate | 30 wt. % granules |
| sodium metasilicate | 14 wt. % granules |
| sodium carbonate | 17 wt. % powder |
| tetrasodium acetodiphosphonate | 5 wt. % powder |

All granular constituents had a particle size within the range 250-500 μm.

Sachet Filled with Powder:

| | |
|---|---|
| sodium tri(polyphosphate) | 10 wt. % powder |
| sodium NTA | 24 wt. % powder |
| sodium percarbonate | 30 wt. % powder |
| sodium metasilicate | 14 wt. % powder |
| sodium carbonate | 17 wt. % powder |
| tetrasodium acetodiphosphonate | 5 wt. % powder |

All powder constituents had a particle size<180 μm.
Tablet:

The same composition as used for the powder was used and compacted to a tablet under a pressure of 8.107 N m².

Results:

| | Dissolution time |
|---|---|
| | (min) |
| Sachet (granular) | 0.75 |
| Sachet (powder) | 30 |
| Tablet | 70 |

1. A unit dose detergent for cleaning a coffee machine consisting of a water-soluble sachet filled with a composition comprising:
a) 10-40 wt. % of a sequestering agent;
b) 15-50 wt. % of a persalt or peracid;
c) 0.1-10 wt. % of a scale inhibitor selected from phosphonate and a carboxyl-functional polymer;
d) a sufficient amount of an alkaline compound to obtain a pH of at least 10 when the composition is dissolved in water; and
e) optionally, to a total of 100 wt. % of ingredients a) to e) of at least one auxiliary agent;
wherein 30-100 wt. % of the total of a) to e) is in the form of granules having a mean particle size 250-800 μm, a BET specific surface area of less than 100 m²/g, and a dissolution rate of less than 1 min in 100 ml of water at 90° C.

2. The unit dose of claim 1 wherein the sachet is made of polyvinylalcohol.

3. The unit dose of claim 1 wherein the composition comprises:
a) 20-30 wt. % of the sequestering agent;
b) 25-35 wt. % of the persalt or peracid; and
c) 3-7 wt. % of the scale inhibitor;
wherein 60-80 wt. % of the total of a) to d) is in the form of granules having a particle size of 300-750 μm.

4. The unit dose of claim 1 wherein the composition further comprises a phosphate and optionally other auxiliary agents.

5. The unit dose of claim 1 wherein the sequestering agent is nitrilotriacetic acid, methylglycine-diacetic acid, ethylenediamine tetraacetic acid, ethylenediamine-N,N′-disuccinic acid, or a mixture thereof.

6. The unit dose of claim 1 wherein b) is alkali metal percarbonate or perborate.

7. the unit dose of claim 1 wherein the scale inhibitor is a phosphonate.

8. A method of cleaning a coffee machine by dissolving the unit dose detergent of claim 1 in water in the water tank of the coffee machine, and discharging the tank after dissolution.

9. The unit dose of claim 2 wherein the composition comprises:
a) 20-30 wt. % of the sequestering agent;
b) 25-35 wt. % of the persalt or peracid; and
c) 3-7 wt. % of the scale inhibitor;
wherein 60-80 wt. % of the total of a) to d) is in the form of granules havng a particle size of 300-750 μm.

10. The unit dose of claim 2 wherein the composition further comprises a phosphate and optionally other auxiliary agents.

11. The unit dose of claim 3 wherein the composition further comprises a phosphate and optionally other auxiliary agents.

12. The unit dose of claim 2 wherein the sequestering agent is nitrilotriacetic acid, methylglycine-diacetic acid, ethylenediamine tetraacetic acid, ethylenediamine-N,N′-disuccinic acid, or a mixture thereof.

13. The unit dose of claim 3 wherein the sequestering agent is nitrilotriacetic acid, methylglycine-diacetic acid, ethylenediamine tetraacetic acid, ethylenediamine-N,N′-disuccinic acid, or a mixture thereof.

14. The unit dose of claim 4 wherein the sequestering agent is nitrilotriacetic acid, methylglycine-diacetic acid, ethylenediamine tetraacetic acid, ethylenediamine-N,N′-disuccinic acid, or a mixture thereof.

15. The unit dose of claim 2 wherein b) is alkali metal percarbonate or perborate.

16. The unit dose of claim 3 wherein b) is alkali metal percarbonate or perborate.

17. The unit dose of claim 4 wherein b) is alkali metal percarbonate or perborate.

18. The unit dose of claim 5 wherein b) is alkali metal percarbonate or perborate.

19. The unit dose of claim 2 wherein the scale inhibitor is a phosphonate.

20. The unit dose of claim 3 wherein the scale inhibitor is a phosphonate.

21. The unit dose of claim 4 wherein the scale inhibitor is a phosphonate.

22. The unit dose of claim 5 wherein the scale inhibitor is a phosphonate.

23. The unit dose of claim 6 wherein the scale inhibitor is a phosphonate.

24. A method of cleaning a coffee machine by dissolving the unit dose detergent of claim 2 in water in the water tank of the coffee machine, and discharging the tank after dissolution.

25. A method of cleaning a coffee machine by dissolving the unit dose detergent of claim 3 in water in the water tank of the coffee machine, and discharging the tank after dissolution.

26. A method of cleaning a coffee machine by dissolving the unit dose detergent of claim 4 in water in the water tank of the coffee machine, and discharging the tank after dissolution.

27. A method of cleaning a coffee machine by dissolving the unit dose detergent of claim 5 in water in the water tank of the coffee machine, and discharging the tank after dissolution.

28. A method of cleaning a coffee machine by dissolving the unit dose detergent of claim 6 in water in the water tank of the coffee machine, and discharging the tank after dissolution.

29. A method of cleaning a coffee machine by dissolving the unit dose detergent of claim 7 in water in the water tank of the coffee machine, and discharging the tank after dissolution.
